(19) United States
(12) Patent Application Publication
(10) Pub. No.: US 2006/0095867 A1
(43) Pub. Date: May 4, 2006

(54) Cursor locator on a display device

(75) Inventors: Mark Daniel Rogalski, Leander, TX (US); David Paul Kuiken, Round Rock, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(73) Assignee: INTERNATIONAL BUSINESS MACHINES CORPORATION, ARMONK, NY (US)

(21) Appl. No.: 10/981,254

(22) Filed: Nov. 4, 2004

(51) Int. Cl. G06F 3/00; G06F 17/00

(52) U.S. Cl. 715/858; 715/856

(57) ABSTRACT

The present invention is a method and system which automatically presents a more visible cursor upon an occurrence of an event. For example, a cursor may be automatically relocated to a specified position on a computer display screen upon occurrence of an event, such as lapse of a period of time to enhance the computing experience for a user. Additionally, the cursor may be enlarged, flashed or otherwise more prominently displayed to aid a user in locating the cursor upon the display of a computing device.

### FIELD OF THE INVENTION

The present invention generally relates to the field of computer displays, and more particularly to a method and system for prominently displaying a cursor upon occurrence of an event.

### BACKGROUND OF THE INVENTION

As the dependency upon computers continues to increase, more efficient and less cumbersome computer interaction is desirable. Conventional computing systems provide for user input via a keyboard and a cursor control device, such as a mouse. Typically, manipulation of a cursor control device, such as a mouse, controls movement of a pointer or cursor on a display of a computing system and control of particular functions.

Although implementation of operating systems with graphical displays has greatly simplified computer interaction, inefficiency is still present within the system under certain conditions. For instance, users of computing systems which employ on-screen cursors often have trouble finding the cursor on the display screen of the computing system after a period of inactivity, especially in systems with hibernation modes and screen savers. Further, some applications use small or narrow cursors while others purposely hide the cursor over certain screen areas. In such applications, it is difficult for a user to locate the cursor even if the user has an idea of where to look. As a result, the user is forced to manipulate the cursor control device causing movement of the cursor in an attempt to locate the cursor. This causes inefficiency and reduces the enjoyment of the computing experience for the user.

Therefore, it would be desirable to create a method and a system which would automatically present the cursor upon an occurrence of an event whereby the cursor is more easily visible to a user.

### SUMMARY OF THE INVENTION

Accordingly, the present invention is a method and system that automatically presents the cursor whereby the cursor is more easily visible to a user upon an occurrence of an event.

In one embodiment of the invention, a method and system which automatically relocates a cursor to a specified position on a display upon occurrence of an event is disclosed. In an exemplary embodiment, the system includes a display screen for displaying the cursor. A cursor control device, otherwise known as an input device, controls movement of the cursor on the display screen whereby the input device allows movement in two dimensions. Upon detection of an occurrence of an event, the cursor may be automatically relocated to a specified position. In alternative embodiments of the invention, the size of a cursor may increase, the color of a cursor may change, the shape of the cursor may change or the cursor may flash upon detection of an occurrence of an event whereby the cursor is more easily visible to a user.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention

### BRIEF DESCRIPTION OF THE DRAWINGS

The numerous advantages of the present invention may be better understood by those skilled in the art by reference to the accompanying figures in which:

FIG. 1 is a flow diagram illustrating a method for automatically presenting a cursor whereby the cursor is more easily visible to a user upon an occurrence of an event;

FIG. 2 is a flow diagram illustrating a method for the automatic relocation of a graphically displayed cursor to a specified position on a display when a period of time of inactivity has lapsed

FIG. 3 is an illustration of a display whereby a cursor has been automatically relocated to a center of a display upon detection of an event from an original location in the bottom portion of a display;

FIG. 4 is an illustration of a display whereby a cursor has been automatically enlarged to aid visibility of the cursor;

FIG. 5 is an illustration of a display whereby a shape of a cursor has been changed to aid visibility of the cursor; and

FIG. 6 is an illustration of a computing system in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

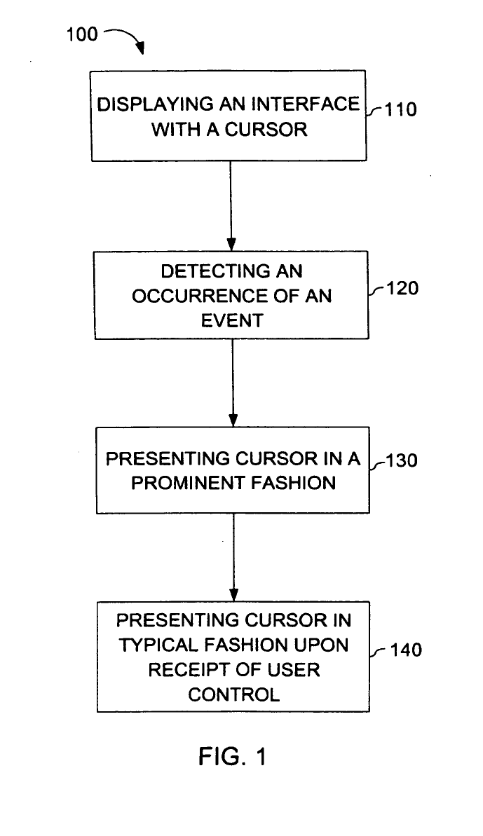

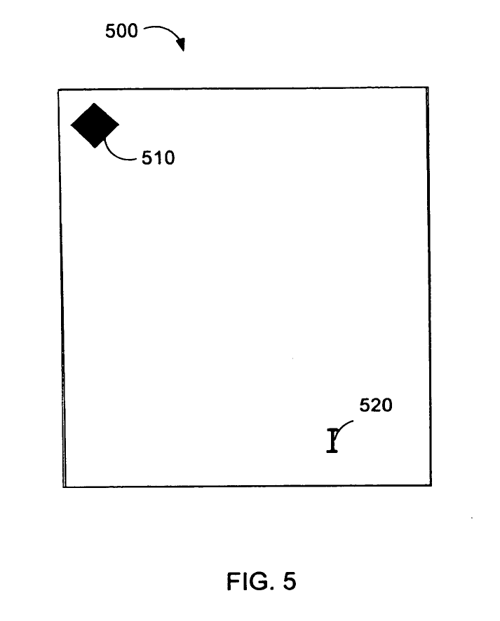

Referring generally to FIGS. 1-6, embodiments of a method and system for prominently displaying a cursor upon occurrence of an event are disclosed. In an advantageous aspect of the present invention, upon the occurrence of an event, such as an expiration of a period of time, the cursor may be more prominently displayed. This is advantageous as it may provide an enhanced computing experience for the user whereby the user may configure the color, shape, and/or location of a cursor upon an occurrence of an event to aid in visibility of the cursor and remove the inefficiency associated with searching for a cursor.

Referring to FIG. 1, an embodiment of a flow diagram illustrating a method 100 for automatically presenting a cursor whereby the cursor is more easily visible to a user upon an occurrence of an event is shown. Method 100 may begin upon the display of an interface 110 upon a computing device. The interface may be a graphical user interface. A graphical user interface may be a display with a cursor controlled by an input device of a computing device such as a personal computer, personal digital assistant, web browser, and the like. It is contemplated that the present invention may be incorporated with any type of interface with a cursor, such as word processing applications, electronic mail programs, web pages, games and the like without departing from the scope and intent of the present invention.

The next step may be detection of an event 120. An event may be user configurable, such as the lapsing of a period of time of inactivity. Advantageously, the period of time of inactivity may be adjustable, and may be user configurable. In one embodiment of the invention, inactivity may refer to a lack of detected movement of the cursor. It is contemplated that various mechanisms exist for determining a lack of activity of a computing system by those with ordinary skill in the art without departing from the scope and intent of the present invention. Additionally, the event may be receipt of a user-controlled command. For instance, the cursor may be relocated upon a user clicking both the left and right buttons of a mouse simultaneously or, in the alternative, doubling clicking the third button on a mouse. Additionally, detection of an event may be the receipt of user input information on a first page of a multi-page document, whereby the cursor may be automatically placed at another user information box of the next page.

Upon detection of an event, the cursor may be more visibly presented 130. In embodiments of the invention, presentation of the cursor in accordance with the present invention may include automatic relocation to a specified position of a display, such as the top of the screen, center of a screen, lower left/right side of a screen, and the like. Additionally, presentation of the cursor in accordance with the present invention may include flashing of a cursor, enlargement of the cursor, presenting the cursor in a unique color, shape and the like. Flashing of a cursor may refer to the blinking of a cursor, on and off, whereby the flashing cursor is more easily visible to a user.

In an advantageous aspect of the present invention, the mechanism employed for presenting the cursor in a more visible fashion may be user configurable. For instance, the user may be capable of selecting a specified location for automatic relocation of the cursor. Additionally, the user may specify a certain size of the cursor. Furthermore, the user may be capable of selecting a shape from a list of shapes or may be able to provide a graphical image which may be utilized as the cursor upon an occurrence of an event.

In the relocation of the cursor to a specified position, such as the center of a display, it is possible that the center of the screen may be an area in which the mouse cursor is small or hidden. Therefore, the cursor may be displayed in a small transparent window. When the cursor leaves this window, it will return to the appropriate shape for the screen area, and the transparent window is destroyed.

After the cursor has been presented in a more prominent fashion to aid visibility of the cursor, it is contemplated that the cursor may be presented in typical fashion upon receipt of user control 140. User control may include detection of movement of an input device, receipt of an input device command, and the like. For example, a user may specify that the cursor is automatically enlarged and placed in the top right portion of a screen upon the detection of an occurrence of an event. When movement of the input device is detected, the cursor may move from the position in the top right portion of the screen and may return to the size, shape and color as originally provided, (i.e. the size, color and shape before modification to aid visibility for the user in accordance with the present invention).

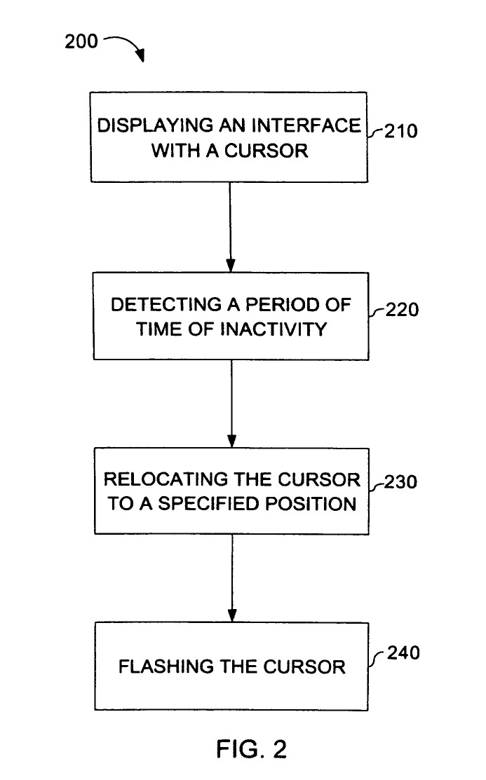

Referring to FIG. 2, a flow diagram illustrating a method 200 for the automatic relocation of a graphically displayed cursor to a user-specified position on a display when a period of time of inactivity has lapsed is shown. Method 200 may begin upon displaying an interface with a cursor 210. Detection of a period of time of inactivity 220 may cause the automatic relocation of the cursor to a user-specified position of a display 230. Additionally, the cursor may be flashed after relocation to the specified location to further aid in visibility of the cursor 240. In an embodiment of the invention, the period of time may be several seconds to several hours. Additionally, the period of time may be adjustable and user configurable.

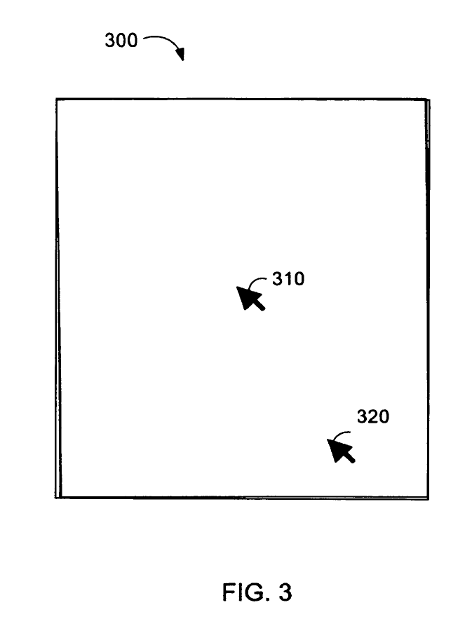

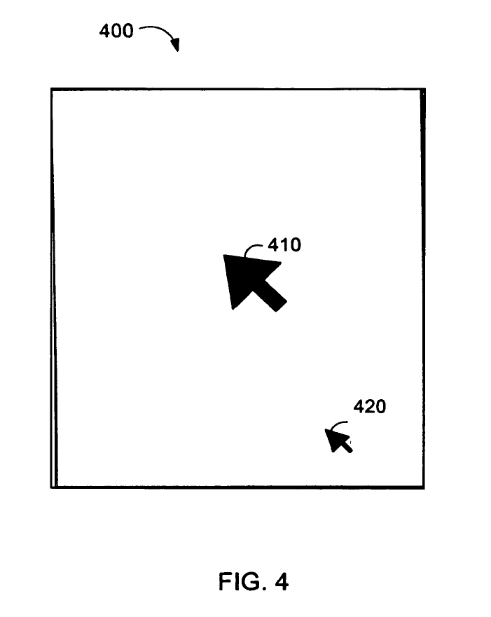

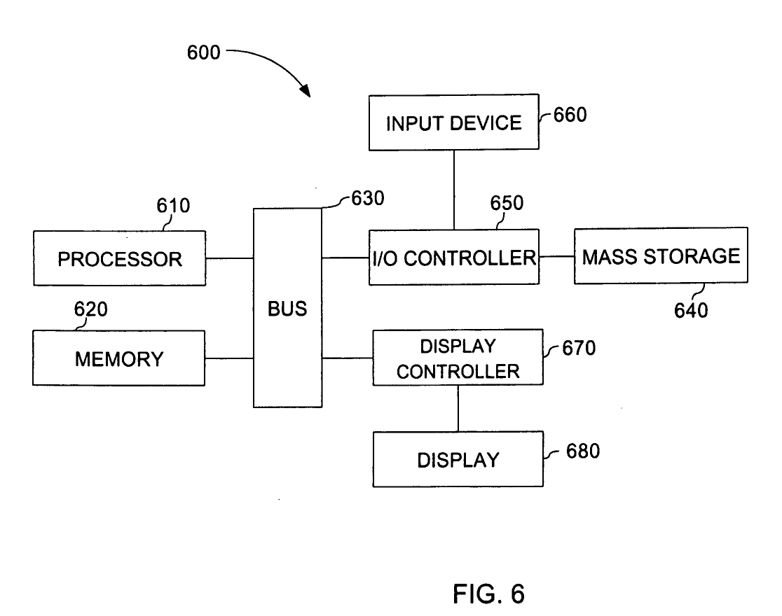

Referring to FIG. 3, an embodiment of a display 300 whereby a cursor has been automatically relocated to a center of a display upon detection of an event from an original location in the bottom portion of a display. Referring to FIG. 4, an embodiment of a display 400 whereby an enlarged cursor 410 for aiding visibility is shown in comparison with a cursor 420 of typical operation. Referring to FIG. 6, an illustration of a display 600 whereby a shape of a cursor has been changed to aid visibility of the cursor is shown. Display 600 may be representative of a word processing application where the cursor may be in the form of a capital “I” shape 520. After the detection of an occurrence of an event, the cursor may be relocated to a user-specified position and may change its shape 510 to aid visibility for the user.

It is contemplated that multiple ways of presenting the cursor in a more visible fashion may be employed, such as placing an enlarged cursor in the center of a display without departing from the scope and spirit of the present invention. Additionally, it is contemplated that other ways of displaying a cursor in a more visible fashion may be employed by those with ordinary skill in the art without departing from the scope and spirit of the present invention.

FIG. 6 illustrates a computing system 600 for automatically presenting a cursor whereby the cursor is more visible to a user upon detection of an event in accordance with the present invention. Computing system 600 may include a processor 610, memory 620 (e.g. RAM), a bus 630 which couples the processor and memory, a mass storage device 640 (e.g. a magnetic or optical disk) coupled to the processor 610 and memory 620 through an input output (I/O) controller 660.

A display controller 670 coupled to bus 630 may allow for a generation of a display on a display device 680. The display controller 670 may comprise a video display adapter having all of the devices for driving the display 680, including video random access memory (VRAM), buffer, and graphics engine as desired. A display 680 may comprise a liquid-crystal display (LCD), or may comprise alternative display technologies, such as a light-emitting diode (LED) display, gas or plasma display, or employ flat-screen technology.

An input/output (I/O) controller 660 may allow for user input via I/O devices. I/O controller 660 may comprise one or more controllers or adapters for providing interface functions between one or more input devices 660, such as a mouse, joystick, trackball, trackpad, trackstick and the like. It is contemplated that display 680 is capable of displaying an interface with a cursor whereby the cursor is controlled by the input device 660. Through execution of executable instructions stored in memory 620 or mass storage device 640, computing system 600 may automatically present a prominent cursor upon detection of the occurrence of an event. Additionally, computing system may be capable of performing methods 100, 200 of FIGS. 1-2 as program instructions.

In an exemplary embodiment, input device 660 is a mouse. However, it is understood that a number of different pointing devices including a trackball on a keyboard, a touch pad and the like may serve as input devices. Thus, all devices which embody the same concept as a mouse: two-dimensional controlled motion of the hand or fingers that translates into similar motion on the display 680, may be employed and are encompassed by the present invention.

It is believed that the present invention and many of its attendant advantages will be understood by the foregoing description. It is also believed that it will be apparent that various changes may be made in size, materials, shape, form, function, manner of operation, assembly and use of the components thereof without departing from the scope and spirit of the invention or without sacrificing all of its material advantages. The form herein before described being merely an explanatory embodiment thereof. Further, it is contemplated that the specific order or hierarchy of steps in the method can be rearranged while remaining within the scope and spirit of the present invention. It is the intention of the following claims to encompass and include such changes.

What is claimed is:

1. A method, comprising the steps of:
displaying an interface including a cursor on a display;
detecting an occurrence of an event; and
relocating the cursor at a specified position on said display upon said occurrence of said event.

2. The method as claimed in claim 1, wherein said event is a user-controlled command.

3. The method as claimed in claim 1, wherein said event is lapse of a period of time.

4. The method as claimed in claim 1, wherein said specified position is user configurable.

5. The method as claimed in claim 1, further comprising enlarging a size of said cursor upon said detection of said occurrence of said event.

6. The method as claimed in claim 5, further comprising reducing said size of said cursor upon detection of movement of said cursor.

7. The method as claimed in claim 1, further comprising flashing said cursor upon said occurrence of said event.

8. The method as claimed in claim 1, wherein said specified position location includes a visible window.

9. The method as claimed in claim 1, wherein a shape of said cursor is modified upon detection of said occurrence of said event.

10. The method as claimed in claim 9, wherein a modified shape of said cursor is user configurable.

11. A computer readable medium containing program instructions for presenting a cursor, the program instructions comprising:
displaying an interface including a cursor on a display;
detecting an occurrence of an event; and
relocating the cursor at a specified position on said display upon said occurrence of said event.

12. The computer readable medium as claimed in claim 11, wherein said event is a user-controlled command.

13. The computer readable medium as claimed in claim 11, wherein said event is lapse of a period of time.

14. The computer readable medium as claimed in claim 11, further comprising enlarging a size of said cursor upon said occurrence of said event.

15. The computer readable medium as claimed in claim 14, further comprising reducing said size of said cursor upon detection of movement of said cursor.

16. The computer readable medium as claimed in claim 11, further comprising flashing said cursor upon said occurrence of said event.

17. A method, comprising the steps of:
displaying an interface including a cursor on a display;
detecting a lapse of a period of time of inactivity;
relocating said cursor at a specified position on said display upon said lapse of said period of time of inactivity; and
flashing said cursor upon said occurrence of said lapse of said period of time of inactivity.

18. The method as claimed in claim 17, further comprising enlarging a size of said cursor upon said lapse of said period of time of inactivity.

19. The method as claimed in claim 18, further comprising reducing said size of said cursor upon user-controlled movement of said cursor.

21. The method as claimed in claim 17, wherein inactivity includes lack of detected movement of said cursor for said period of time.

22. The method as claimed in claim 17, wherein said period of time is user adjustable.
